(19) United States
(12) Patent Application Publication
(10) Pub. No.: US 2023/0130300 A1
(43) Pub. Date: Apr. 27, 2023

(54) A SEMI-PERMEABLE MEMBRANE

(71) Applicant: National University of Singapore, Singapore (SG)

(72) Inventors: Daria Andreeva-Baeumler, Singapore (SG); Konstantin Novoselov, Singapore (SG); Antonio Helio Castro Neto, Singapore (SG)

(21) Appl. No.: 17/914,304

(22) PCT Filed: Mar. 23, 2021
(86) PCT No.: PCT/SG2021/050158

§ 371 Date: Sep. 23, 2022

(30) Foreign Application Priority Data
Mar. 24, 2020 (SG) 10202002709R

(51) Int. Cl. B01D 71/02; B01D 69/02; B01D 71/60; B01D 67/00

(52) U.S. Cl. CPC B01D 71/0211; B01D 69/02; B01D 71/601; B01D 67/00791; B01D 67/0095; B01D 2325/04; B01D 2323/40

(57) ABSTRACT

There is provided a semi-permeable membrane comprising: at least two two-dimensional (2D) heterostructure layers of; and a polyelectrolyte layer between each 2D heterostructure layer of the at least two 2D heterostructure layers. There is also provided a method of preparing the membrane comprising: mixing a 2D heterostructure solution and a polyelectrolyte solution to form a mixture; and vacuum filtering the mixture onto a substrate to form the membrane.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

The present invention relates to a semi-permeable membrane and a method for forming the same.

### BACKGROUND

Membranes that are able to adjust their permittivity or selectivity are particularly useful in many applications. For example, two-dimensional (2D) membranes have been developed—nanoporous graphene (NG) membrane and lamellar graphene oxide (GO) membrane. NG membranes are selective for various gas mixtures and show barrier properties for ions. However, NG membranes require expensive and sophisticated methods for pore formation including ultraviolet-induced oxidative etching, ion bombardment, and oxygen-plasma etching techniques. It has been shown that the nanometer-sized pores in single layer graphene can effectively desalinate NaCl from water. Further, NG membranes exhibit a salt rejection of nearly 100% while allowing rapid water transport. This shows that NG membranes block transport of all ions and do not show any selective transport, thereby making them suitable for water purification applications. However, NG membranes are not suitable for practical applications due to a difficulty in graphene transfer and pore-drilling procedures.

Other known filtration membranes known in the art include membranes comprising overlapped and stacked GO nanosheets. GO membranes have several with engineering problems: the mechanical strength of pristine GO membranes is not high enough to resist the high pressures that are used in practical filtration and separation applications in aqueous environment. While chemical crosslinking has been applied to GO membranes to improve the mechanical strength of the membranes, the covalent bonding of functional groups leads to the formation of sp3 carbon atoms and thereby reduces mass transport properties of 2D nanochannels within the membrane.

Thus, there is a need for an improved membrane.

### SUMMARY OF THE INVENTION

The present invention seeks to address these problems, and/or to provide an improved membrane, particularly a membrane comprising a two-dimensional (2D) material.

According to a first aspect, the present invention provides a semi-permeable membrane comprising:
at least two two-dimensional (2D) heterostructure layers; and
a polyelectrolyte layer between each 2D heterostructure layer of the at least two 2D heterostructure layers.

The membrane may be formed by self-assembly of the at least two 2D heterostructure layers and the polyelectrolyte layer. According to a particular aspect, each 2D heterostructure layer of the at least two 2D heterostructure layers and the polyelectrolyte layer may be bonded to one another via electrostatic interactions, hydrogen bonds, van der Waals interaction, hydrophobic interaction, or a combination thereof.

The at least two 2D heterostructure layer may be formed by any suitable method. For example, the at least two 2D heterostructure layers may be formed via layer-by-layer assembly.

The 2D heterostructure layer may comprise any suitable material. For example, the 2D heterostructure layer may comprises, but is not limited to: graphene, graphene-oxide, hexagonal boron nitride (hBN), silicon, doped graphene, hydrogenated graphene, fluorinated graphene, amorphous carbon, amorphous graphene, transition metal dichalcogenides, 2D transition metal carbides, 2D transition metal nitrides, 2D metal oxides, or a combination thereof.

The polyelectrolyte layer may comprise any suitable polyelectrolyte. For example, the polyelectrolyte layer may comprise, but is not limited to: proteins, polybases, polyacids, polynucleotides, polysaccharides, or a combination thereof.

The average interlayer distance between each 2D heterostructure layer of the at least two 2D heterostructure layers may be 1-3 nm.

The membrane may be of any suitable thickness. For example, the membrane may have an average thickness of 50 nm-100 μm.

According to a particular aspect, the membrane may be a free-standing membrane. Accordingly, the membrane may have an average thickness of 1000 nm.

According to another particular aspect, water flux through the membrane may be controlled by changes in internal osmotic pressure within the membrane.

The present invention also provides a method of preparing the membrane according to the first aspect, the method comprising:
mixing a 2D heterostructure solution and a polyelectrolyte solution to form a mixture; and
vacuum filtering the mixture onto a substrate surface to form the membrane.

According to a particular aspect, the 2D heterostructure solution may comprise any suitable heterostructure material. For example, the 2D heterostructure solution may comprise, but is not limited to, graphene, graphene-oxide, hexagonal boron nitride (hBN), transition metal dichalcogenides, 2D transition metal carbides, 2D transition metal nitrides, 2D metal oxides, or a combination thereof.

The polyelectrolyte solution may comprise any suitable polyelectrolyte. For example, the polyelectrolyte solution may comprise, but is not limited to, proteins, polybases, polyacids, polynucleotides, polysaccharides, or a combination thereof.

The mixture formed from the mixing may be a colloidal mixture. Accordingly, the method may further comprise centrifuging the colloidal mixture to separate particles from the colloidal mixture.

According to a particular aspect, the method may further comprise drying the membrane following the vacuum filtering.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1A shows a photograph of a 1 μm thick free-standing GO-PEI membrane; FIG. 1B shows a schematic representation of a sandwich configuration of a membrane according to one embodiment of the present invention; FIG. 1C shows the height profile of GO flakes assembled with PEI at pH 2; FIG. 1D shows X-ray reflection spectra for a GO-PEI membrane prepared at pH 2 (top), at pH 10.2 (middle) and GO without PEI (bottom) with calculated inter-layer distances; FIG. 1E shows schematic representations of the membrane structures corresponding to GO-PEI membranes prepared at pH 2 (top), at pH 10.2 (middle) and GO without PEI (bottom); FIG. 1F shows the height profile of GO flakes assembled with PEI at pH 10.2;

FIG. 2A shows cross-section analysis of lithographically scratched GO-PEI membrane surfaces; FIG. 2B shows oscillations of the depth of the scratch and water flux at pH 4 and 5.5; FIG. 2C shows oscillations of water permeability of the membranes prepared at pH 2, 4, 5.5 and 10.2; FIG. 2D shows a schematic illustration of the mechanisms of open/close state transitions in the membranes based on pH dependent oscillation of osmotic pressure in GO-PEI-GO sandwiches that drives water penetration in the interior of the membranes;

FIG. 3A shows pH ionic permeation of the GO-PEI membranes as a function of the hydrated radii of ions for 0.1M mixture of ions adjusted to pH 2 and 5.5; FIG. 3B shows ionic permeation of the GO-PEI membranes as a function of pH, measured separately for K⁺ and Na⁺; and

FIG. 4 shows potentiometric titration curves for suspensions of GO (left), PEI (middle), and GO flakes assembled with PEI (right) in the presence of 0.1M potassium chloride and sodium chloride.

### DETAILED DESCRIPTION

As explained above, there is a need for an improved membrane, particularly one which can change its properties such as permittivity and/or selectivity.

In general terms, the present invention provides a semi-permeable membrane which is able to adjust itself to appropriate external conditions such as, but not limited to, pH, ionic concentration, light, temperature, electrical fields, magnetic fields, ultrasound, or a combination thereof. This may be in response to cells, bacteria, biofilms, yeasts, and/or microorganisms. The membrane according to the present invention may be a layered membrane prepared by self-assembly of two-dimensional (2D) heterostructures with polyelectrolytes. The membrane may exhibit regulated permittivity for water, organic solvents, organic vapours and/or ionic solutions. In particular, the membrane may be able to separate monovalent ions.

According to a first aspect, the present invention provides a semi-permeable membrane comprising:
at least two two-dimensional (2D) heterostructure layers; and
a polyelectrolyte layer between each 2D heterostructure layer of the at least two 2D heterostructure layers.

Each 2D heterostructure layer of the at least two 2D heterostructure layer and the polyelectrolyte layer may be bonded to one another by suitable non-covalent bonds. For example, each of the at least two 2D heterostructure layers and the polyelectrolyte layer may be bonded to one another via electrostatic interactions, hydrogen bonds, van der Waals interaction, hydrophobic interaction, or a combination thereof. In particular, the electrostatic bond between each of the 2D heterostructure layer of the at least two 2D heterostructure layers and the polyelectrolyte layer may be by van der Waals interaction. The electrostatic bonding between the 2D heterostructure layer and the polyelectrolyte layer may result in the membrane being highly stable and robust, thereby having favourable mechanical properties. In this way, the membrane is able to withstand high pressures that are used in practical filtration and separation applications in aqueous environment.

The membrane may be formed by self-assembly of the at least two 2D heterostructure layers and the polyelectrolyte layer.

According to a particular aspect, the at least two 2D heterostructure layer may be formed by any suitable method. For example, the at least two 2D heterostructure layers may be formed via layer-by-layer assembly. In particular, the at least two 2D heterostructure layers may be formed by self-assembly.

The 2D heterostructure layer may comprise any suitable material. In particular, the 2D heterostructure layer may comprise any suitable 2D material. For example, the 2D heterostructure layer may comprises, but is not limited to: graphene, graphene-oxide, hexagonal boron nitride (hBN), silicon, doped graphene, hydrogenated graphene, fluorinated graphene, amorphous carbon, amorphous graphene, transition metal dichalcogenides, 2D transition metal carbides, 2D transition metal nitrides, 2D metal oxides, or a combination thereof. For example, the transition metal dichalcogenides may comprise, but is not limited to, sulphides, selenides, and tellurides of molybdenum, tungsten, indium, zinc, cadmium, titanium, or a combination thereof. In particular, the 2D heterostructure layer may comprise graphene oxide, 2D iron, nickel, copper, cobalt, ruthenium-carbon hybrids, or a combination thereof. Even more in particular, the 2D heterostructure layer may comprise graphene oxide.

According to a particular aspect, each of the at least two 2D heterostructure layers may be an atomically thin layer.

According to another particular aspect, each of the two 2D heterostructure layers may comprise a 2D heterostructure in any suitable form. For example, the 2D heterostructure comprised in the 2D heterostructure layer may comprise 2D heterostructure flakes, 2D heterostructure nanoparticles, 2D heterostructure microparticles, 2D heterostructure quantum dots, 2D heterostructure frameworks. In particular, the 2D heterostructure layer may comprise 2D heterostructure flakes. The 2D heterostructure flakes may have any suitable dimensions. For example, the 2D heterostructure flakes may have an average lateral size of 100-5000 nm and a thickness of 1-2 nm.

The polyelectrolyte layer may comprise any suitable polyelectrolyte. According to a particular aspect, the polyelectrolyte may be any suitable polyelectrolyte which exhibits pH dependent behaviour. For example, the polyelectrolyte layer may comprise, but is not limited to: proteins, polybases, polyacids, polynucleotides, polysaccharides, or a combination thereof. In particular, the polyelectrolyte may be, but not limited to, polyallylamine, polyethyleneimine, poly(diallyldimethylammonium), poly(methacryloyloxyethyl trimethylammonium chloride), heparin, chitosan, cellulose and its derivatives, silk proteins, DNA, poly(styrenesulfonate), polyacryic acid, polylysine, polyornithine, or a combination thereof.

The average interlayer distance between each 2D heterostructure layer of the at least two 2D heterostructure layers may be 1-3 nm. In particular, the average interlayer distance between each 2D heterostructure layer of the at least two 2D heterostructure layers may be about 2 nm.

The membrane may be of any suitable thickness. For example, the membrane may have an average thickness of 50 nm-100 μm. In particular, the membrane may have a thickness of 75-50,000 nm, 100-25,000 nm, 125-10,000 nm, 150-5,000 nm, 175-2,500 nm, 200-1,000 nm, 250-900 nm, 275-750 nm, 300-700 nm, 350-650 nm, 400-500 nm. Even more in particular, the membrane may have an average thickness of about 250 nm.

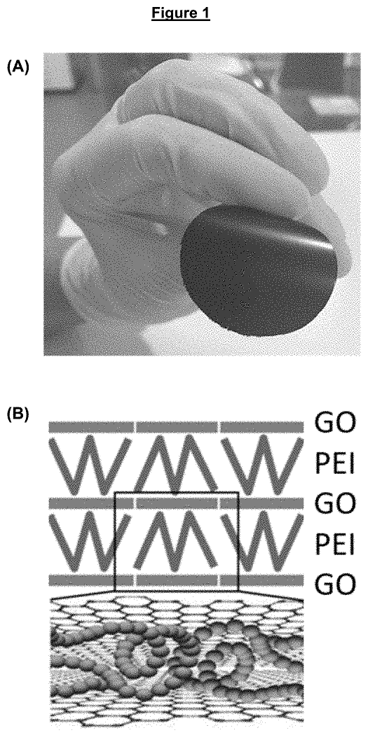

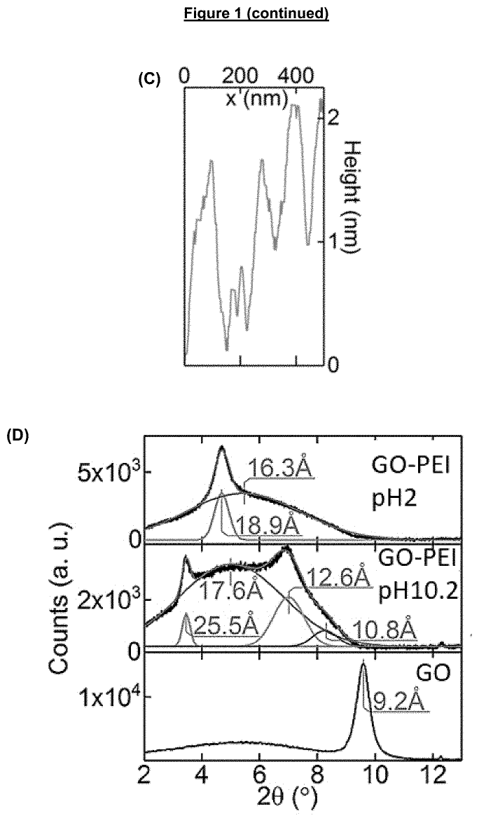

According to a particular aspect, the membrane may be a free-standing membrane. The free-standing membrane may be a flexible free-standing membrane. In particular, the free-standing membrane may be formed by forming a thicker membrane. In particular, the free-standing membrane may have an average thickness of 1000 nm. FIG. 1A shows a 1 μm-thick free-standing GO-PEI membrane.

According to another particular aspect, water flux through the membrane may be controlled by changes in internal osmotic pressure within the membrane. In particular, the transport through the membrane may be controlled based on the environmental conditions that the membrane is utilised in. Accordingly, the membrane may be highly selective, depending on the choice of materials.

For example, the interaction between the polyelectrolyte layer and the 2D heterostructure layer may change based on the conditions in which the membrane is being used. In this way, if the environment in which the membrane is going to be used is known, the material to be comprised in the polyelectrolyte layer and the material of the 2D heterostructure layer may be selected accordingly. This allows fabrication of membranes with different, pre-determined permeation and selectivity properties, controlled by the choice of materials. The membrane according to the present invention does not reject all ions. Instead, the membrane may be selectively opened for particular ions, as explained above.

The membrane according to the present invention is able to exhibit selective and controllable permittivity of different ions and anions. According to a particular aspect, the polyelectrolyte layer may be sandwiched between the 2D heterostructure layers. In particular, the mechanism of molecular and ionic separation may be based not on size-selective sieving but on specific interactions of ions and molecules with the charged components of the membrane. Accordingly, if the surface charge density of the membrane is changed, the mass transport properties through the membrane may also be changed.

The membrane may also heal small defects within the membrane. For example, the defects may be 10-1000 nm in width and/or depth. This may be due to the formation of dynamic nanonetworks between the 2D heterostructure layers and the polyelectrolyte layer. In particular, the mechanism of initiation of dynamic changes in the membranes may be based on water driven rearmament of soft polyelectrolyte segments within a rigid compartment built by 2D heterostructure layers within the membrane. The morphology and polarity of polyelectrolytes may be highly sensitive to environmental perturbations. In particular, the environment, such as the presence of water, pH, ionic concentration, light, temperature, electrical fields, magnetic fields, ultrasound, bacteria, cells, biofilms, or a combination thereof, affects the charge density of polyelectrolytes, as well as the intra- and intermolecular interactions and conformation of polyelectrolyte molecules. Conformational changes, in particular, folding and/or unfolding of polyelectrolytes may create local tension in 2D heterostructure layers. The local tension may trigger sliding of 2D heterostructure layers within the membrane which in turn result in the recovery of defects.

According to a second aspect, there is provided a method of preparing the membrane according to the first aspect, the method comprising:
mixing a 2D heterostructure solution and a polyelectrolyte solution to form a mixture; and
vacuum filtering the mixture onto a substrate surface to form the membrane.

According to a particular aspect, the 2D heterostructure solution may comprise any suitable heterostructure material. For example, the 2D heterostructure solution may comprise, but is not limited to: graphene, graphene-oxide, hexagonal boron nitride (hBN), silicon, doped graphene, hydrogenated graphene, fluorinated graphene, amorphous carbon, amorphous graphene, transition metal dichalcogenides, 2D transition metal carbides, 2D transition metal nitrides, 2D metal oxides, or a combination thereof. For example, the transition metal dichalcogenides may be, but is not limited to, sulphides, selenides, and tellurides of molybdenum, tungsten, indium, zinc, cadmium, titanium, or a combination thereof. In particular, the 2D heterostructure solution may comprise graphene oxide, 2D iron, nickel, copper, cobalt, ruthenium-carbon hybrids, or a combination thereof. Even more in particular, the 2D heterostructure solution may comprise graphene oxide.

According to another particular aspect, the 2D heterostructure solution may comprise a 2D heterostructure in any suitable form. For example, the 2D heterostructure comprised in the 2D heterostructure solution may comprise 2D heterostructure flakes, 2D heterostructure nanoparticles, 2D heterostructure microparticles, 2D heterostructure quantum dots, 2D heterostructure frameworks. In particular, the 2D heterostructure solution may comprise 2D heterostructure flakes. The 2D heterostructure flakes may be as described above.

The polyelectrolyte solution may comprise any suitable polyelectrolyte. For example, the polyelectrolyte solution may comprise, but is not limited to: proteins, polybases, polyacids, polynucleotides, polysaccharides, or a combination thereof. In particular, the polyelectrolyte solution may comprise, but is not limited to, polyallylamine, polyethyleneimine, poly(diallyldimethylammonium), poly(methacryloyloxyethyl trimethylammonium chloride), heparin, chitosan, cellulose and its derivatives, silk proteins, DNA, poly(styrenesulfonate), polyacryic acid, polylysine, polyornithine, or a combination thereof.

The mixing may be under suitable conditions. For example, the mixing may be under controlled pH conditions.

The mixing may be carried out for a pre-determined period of time. In particular, the mixing may be carried out in a shaker to ensure uniform mixing of the polyelectrolyte solution and the 2D heterostructure solution.

The mixture formed from the mixing may be a colloidal mixture. Accordingly, the method may further comprise centrifuging the colloidal mixture to separate particles from the colloidal mixture.

The method may further comprise washing the mixture prior to the vacuum filtering. The washing may be using any suitable solvent. For example, the washing may be using sodium chloride solution at a suitable pH.

The vacuum filtering may be under suitable conditions. For example, the vacuum filtration may be carried out for a pre-determined period of time.

The substrate onto which the membrane is deposited may be any suitable substrate. For example, the substrate may be a supporting filter.

According to a particular aspect, the method may further comprise drying the membrane following the vacuum filtering. The drying may be under suitable conditions. For example, the drying may be in a dry cabinet. The drying may be carried out for a pre-determined period of time.

Having now generally described the invention, the same will be more readily understood through reference to the following example which is provided by way of illustration, and is not intended to be limiting.

### Example

Preparation and Characterization of Membranes

Membranes were prepared by vacuum filtration of colloidal solutions of graphene oxide (GO) flakes (2 mg/mL, dispersion in H₂O, Merck) covered by polyethyleneimine (PEI) (average molecular weight (Mw)˜25,000 by light scattering (LS), average number average molecular weight (Mn)˜10,000 by gel permeation chromatography (GPC), branched, Merck) and PEI (average Mw˜750,000 by LS, Mn˜60,000 by GPC, 50 wt. in H₂O, Merck) on two types of filters: Anodisc 47 (pore size 0.02 μm, diameter 47 mm, Whatman, UK) and polyethersulfone membrane (0.03 μm, 47 mm, Sterlitech Corporation, USA).

Colloidal solutions were prepared by mixing of 5 mL of 0.1 mg/mL solution of GO in deionized water at pH 4.6 and 20 mL of 2 mg/mL solution of PEI in 0.1M sodium chloride (NaCl) at pH 2, pH 4, pH 5.5, pH 9 and pH 10.2, which were adjusted by adding 1M hydrochloric acid (HCl) solution. pH levels were measured by a SevenExcellence pH meter with pH electrode (Mettler Toledo, Switzerland). The colloids were mixed for 5 minutes using a shaker (rotation speed 500 rpm, Vortex Mixer, VORTEX-GENIE® 2, USA).

Thereafter, the particles were sedimented by centrifugation for 90 minutes at 2000 rpm, washed with 0.1M NaCl solutions at the corresponding pH levels for 3 times and filtrated under vacuum on a supporting filter to form a film. The filtration process was approximately 2 hours. The wet films on filters were dried in a dry cabinet for 24 hours before use. GO membranes without PEI were prepared using the same procedure, excluding PEI.

The GO membranes without PEI and GO-PEI membranes were weighed. The average weight of the GO membranes without PEI was 1.6±0.2 mg, and the average weight of GO-PEI membranes was 3±0.2 mg. Thus, mass ratio of GO to PEI for the GO-PEI membranes is 1:1. The thickness of the membranes were measured by atomic force microscopy (AFM). The thickness of the GO-PEI membrane was approximately 250±15 nm.

The membranes had a sandwich-like morphology formed by alternating monomolecular layers of PEI and GO. FIG. 1B shows a schematic representation of the sandwich-like morphology of the GO-PEI membranes, where GO is represented by straight lines and PEI, a polyamine (PA), is represented by zig-zag lines.

The height profiles of the GO-PEI membranes prepared at pH 2 and pH 10.2 were measured, as shown in FIGS. 1C and 1F, respectively. The height profiles prove that GO flakes became completely covered by PEI.

FIG. 1D shows X-ray diffraction (XRD) patterns of the GO-PEI membranes prepared at pH 2 (top) and at pH 10.2 (middle), and that of a GO membrane without PEI (bottom), with calculated inter-layer distances. The inter-layer distance (d-spacing) in typical GO paper is ≈7.2 Å. The XRD patterns of the GO-PEI membranes showed one narrow peak at 4.6 degree and one broad peak at 5.4 degree, and corresponding interlayer distances were calculated at ≈19 Å and ≈16 Å. This confirmed the deposition of stretched polyelectrolyte chains. At pH 10.2, deposition of a monomolecular layer of polyelectrolyte coils led to the heterogeneous structure of membrane. XRD patterns show several peaks, and d-spacing values were calculated from ≈7.2 Å, which is attributed to an inter-layer distance in bare GO paper, to ≈25.5 Å, which indicates adsorption of polymer chains in a coil conformation.

Thus, the GO-PEI membranes consisted of approximately 125 GO-PEI-GO nanosandwiches with interlayer spacing of approximately 2 nm. FIG. 1E shows a schematic representation of the structures of the GO-PEI membranes prepared at pH 2 (top), at pH 10.2 (middle) and GO membrane without PEI (bottom). Upon swelling, the interlayer distance did not increase, but rather, the structure became slightly more compact in a wet state compared to a dry state.

Self-Healing Properties

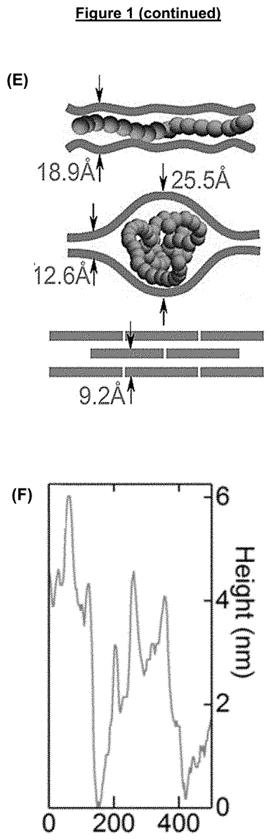

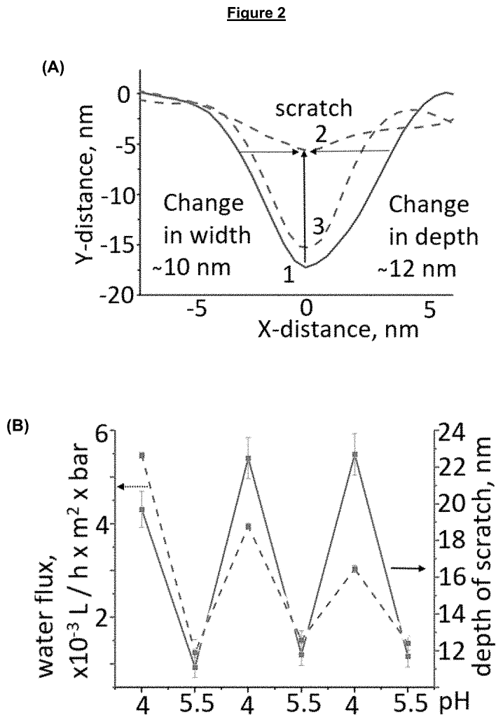

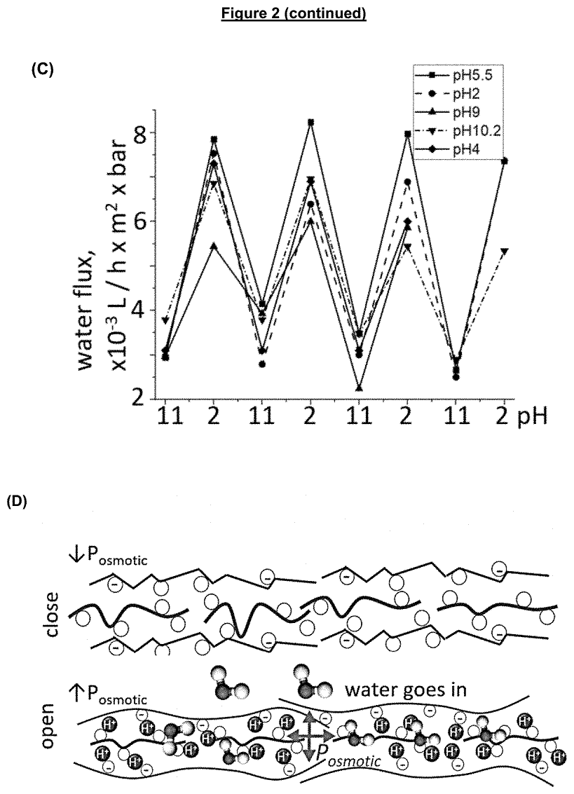

As seen in FIG. 2A, it is possible to manipulate the size of mechanical defects by changing the concentration of protons at physiological values. FIG. 2A is an analysis of the scratch profile of lithographically scratched membrane surfaces. Approximately 10-nm amplitude of oscillations of the width and the depth of membrane can be achieved using low Mw PEI. Higher Mw PEI shows oscillations up to 25 nm. Changing pH at a narrow physiological pH range between 4 and 5.5 was enough to achieve a pronounced morphological and structural change in the membranes. At pH 4, the scratch tended to open. At pH 5.5, the scratch closed. The open/close phases were repeatable for at least three times. Water flux through the membrane demonstrated similar tendency, where the membrane was open for water at pH 4 and closed at pH 5.5. FIG. 2B demonstrated that both the water flux and the size of defects may be reversibly changed at a very narrow pH range due to an oscillation of osmotic pressure in the membranes.

The observed dynamic behaviour of the membranes was due to pH dependent oscillations of the osmotic pressure in the nanosandwiches. Increased osmotic pressure in the membrane interior drove water pumping into the membrane. Transmission electron microscope (TEM) equipped with the flow cell was used for direct visualization of water diffusion into the membrane. It was also observed by TEM that the wrinkled GO flakes were unfolded. A complete self-recovery of the defects in membranes was achieved by using high molecular weight PEI with a larger maximum surface charge density at maximum osmotic pressure at pH 2. At higher osmotic pressure, the GO flakes were able to completely recover integrity of the membranes. The same membrane was sequentially treated by water at pH>6, pH 5.5 and pH 2, and dried in air for 12 hours. The scratch completely closed at pH 2, which was the pH that corresponded to the predicted maximum osmotic pressure in the nanosandwiches.

Regulated Water Transport

Water flux was measured with a H1C Side-Bi-Side diffusion system (PermeGear) equipped with a H1C magnetic stirrer and a heater/circulator. The membrane was placed between two cell halves. In one half of the cell, 2.5 M solution of sucrose (99%, Merck) was added to water to create external osmotic pressure (61 Bar). In the other half of the cell, solutions of pH 2, 4, 5.5 and 10.2 were added, which were adjusted using 1M HCl or 1M NaOH solutions. The permeability tests were conducted for 24 hours.

FIG. 2C shows a switch-on of water flux at pH 2 and switch-off at pH 11 for the membranes prepared at pH 2, 4, 5.5, 9 and 10.2. All the membranes exhibited increased water permeability at pH 2, and decreased water permeability at pH 11. Furthermore, interlayer distances of the membranes did not change upon the use of the membranes at different pH.

Thus, conformational changes as a possible mechanism may be excluded. It can be seen that the main mechanism of dynamic behaviour of the membranes is excess osmotic pressure, as illustrated in FIG. 2D. Accumulation of mobile ions increased osmotic pressure in the nanosandwiches, which triggered water pumping through the membranes, and in turn led to 2D structural rearrangements in the membranes.

Regulated Ionic Transport

Ion permeation through the membranes were tested. The same setup as that for water permeation testing was used, where the membranes were separated into two cells: one cell with 2.5M solution of sucrose, and the other cell with water-based solution of monovalent cations, where the pH and concentration of the four ions Cs⁺, K⁺, Na⁺ and Li⁺ were varied. Two sets of experiments were performed.

In the first experiment, a mixture of 0.1M solutions of the four chloride salts of Cs⁺, K⁺, Na⁺ and Li⁺ were used, at pH 2 and 5.5. Concentration of ions after permeation was measured by inductively coupled plasma-optical emission spectroscopy (ICP-OES) analysis after 24 hours of the permeability test.

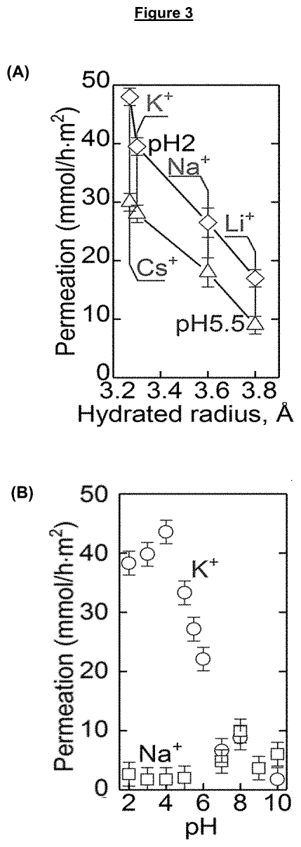

It can be seen from FIG. 3A that the four different ions have very different permeability. Ions with low hydrated radius permeated more than those with larger radius. Furthermore, the ion permeation depended strongly on pH level, where permeation was increased at pH 2. Selective permeation of ions with different hydrated radius has been reported previously. However, the cut-off was observed to happen for significantly larger hydrated ionic radii (around 4.5 Å). Furthermore, interlayer spacing in the GO-PEI membranes were significantly larger (1.9-2.5 nm) than in bare GO membranes (0.9-0.12 nm).

To elucidate further on this finding, the second set of experiments were conducted with just one particular salt solution (either 0.1M solutions of KCl or NaCl) with varied pH. As seen in FIG. 3B, while K⁺ permeation through the membranes is a strong function of the pH level, the permeation of Na⁺ remained low and independent of the pH level. The transport of K⁺ and water demonstrates the similar dependence on pH. Thus, it is suggested that ions in the GO-PEI membranes were transmitted in hydrated state and the permeation of such cluster was governed by osmotic pressure.

In contrast to the above experimental results on the simultaneous permeability of the mixture of ions, solely Na⁺ from 0.1M NaCl solution demonstrated extremely low permeability, as seen in FIG. 3B. It is previously known that the selective transport of K⁺ and Na⁺ in nanoporous GO membranes can be achieved due to cation-π interactions, that the transport of K⁺ is restricted due to its strong affinity to the sp² clusters of GO. It was previously measured that in bare GO membranes K⁺ permeates slower than Na⁺. In general, the fast permeation of small ions in pure GO is explained in terms of capillary pressure. However, in the GO-PEI membranes, a higher permeability for K⁺ was observed.

In the case of GO-PEI membranes, as seen in FIG. 3B, K⁺ permeated twenty times as fast as Na⁺ in acidic media. The permittivity of ions was governed by the osmotic pressure of water, where excessive amount of water inside the GO-PEI membranes at low pH created osmotic pressure for ions to go through. The observed rejection of Na⁺ can be explained by a difference in kinetics of ionic transport.

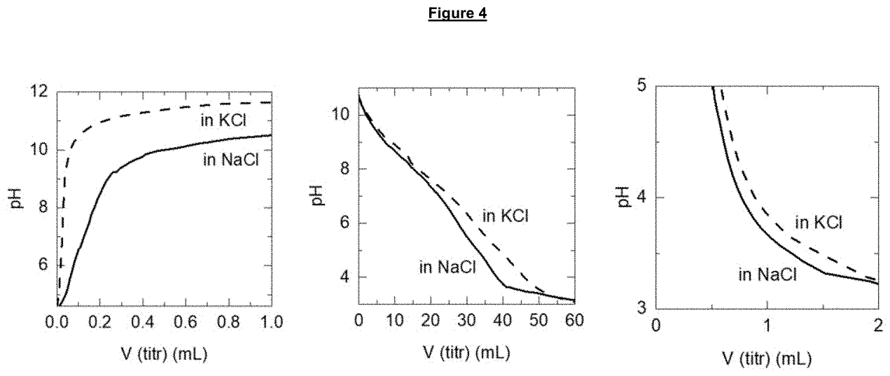

The titration curves in FIG. 4 show that PEI is a relatively stronger base in the presence of NaCl, and thus it can bind more strongly to the acidic groups of GO. Therefore, the observed rejection of Na⁺ in the GO-PEI membranes can be explained, first of all, by the tight packing between GO and polymer molecules in the presence of NaCl. This means that larger hydrated ions penetrate such a network of channels extremely slowly.

However, in the presence of other ions, Na⁺ permeates much faster, as seen in FIG. 3A. This is due to flux of some ions that accelerates transport of other ions in the mixture. As seen in FIG. 4, difference in titration curves for suspensions of GO-PEI in the presence of KCl and NaCl also suggests a slower kinetics of exchange of H⁺/Na⁺ compared to H⁺/K⁺ on the GO-PEI flakes. Hydrated Na⁺ have a higher affinity to the charged groups of GO-PEI composites due to specific interactions that superposed on general electrostatic attractions. Thus, there is clear evidence that in the GO-PEI membranes the strength of poly-ions regulate selective ionic transport. Protons act as antagonists for Na⁺ and agonists for K. It is demonstrated that such mechanism is very efficient for regulated selective K⁺/Na⁺ pumping. Furthermore, transport properties of the GO-PEI membranes can be programmed by the strength of poly-ions.

Whilst the foregoing description has described exemplary embodiments, it will be understood by those skilled in the technology concerned that many variations may be made without departing from the present invention.

1. A semi-permeable membrane comprising:
at least two two-dimensional (2D) heterostructure layers of; and
a polyelectrolyte layer between each 2D heterostructure layer of the at least two 2D heterostructure layers.

2. The membrane according to claim 1, wherein the membrane is formed by self-assembly of the at least two 2D heterostructure layers and the polyelectrolyte layer.

3. The membrane according to claim 1, wherein each 2D heterostructure layer of the at least two 2D heterostructure layers and the polyelectrolyte layer are bonded to one another via electrostatic interactions, hydrogen bonds, van der Waals interaction, hydrophobic interactions, or a combination thereof.

4. The membrane according to claim 1, wherein the membrane comprises the at least two 2D heterostructure layers in a layer-by-layer assembly.

5. The membrane according to claim 1, wherein the 2D heterostructure layer comprises: graphene, graphene-oxide, hexagonal boron nitride (hBN), transition metal dichalcogenides, 2D transition metal carbides, 2D transition metal nitrides, 2D metal oxides, or a combination thereof.

6. The membrane according to claim 1, wherein the polyelectrolyte layer comprises: proteins, polybases, polyacids, polynucleotides, polysaccharides, or a combination thereof.

7. The membrane according to claim 1, wherein average interlayer distance between each 2D heterostructure layer of the at least two 2D heterostructure layers is 1-3 nm.

8. The membrane according to claim 1, wherein the membrane has an average thickness of 50 nm-100 μm.

9. The membrane according to claim 1, wherein the membrane is a free-standing membrane and has an average thickness of 1000 nm.

10. The membrane according to claim 1, wherein water flux through the membrane is controlled by changes in internal osmotic pressure within the membrane.

11. A method of preparing a membrane of claim 1, the method comprising:
mixing a 2D heterostructure solution and a polyelectrolyte solution to form a mixture; and
vacuum filtering the mixture onto a substrate to form the membrane.

12. The method according to claim 11, wherein the 2D heterostructure solution comprises graphene, graphene-oxide, hexagonal boron nitride (hBN), silicon, doped graphene, hydrogenated graphene, fluorinated graphene, amorphous carbon, amorphous graphene, transition metal dichalcogenides, 2D transition metal carbides, 2D transition metal nitrides, 2D metal oxides, or a combination thereof.

13. The method according to claim 11, wherein the polyelectrolyte solution comprises: proteins, polybases, polyacids, polynucleotides, polysaccharides, or a combination thereof.

14. The method according to claim 11, wherein the mixture may be a colloidal mixture.

15. The method according to claim 14, wherein the method further comprises centrifuging the colloidal mixture to separate particles from the colloidal mixture.

16. The method according to claim 11, wherein the method further comprises drying the membrane following the vacuum filtering.
